(19) United States
(12) Patent Application Publication
(10) Pub. No.: US 2022/0143762 A1
(43) Pub. Date: May 12, 2022

(54) DYNAMIC MODE WORK PIECE PROCESSING DEVICE

(71) Applicant: Branson Ultrasonics Corporation, Brookfield, CT (US)

(72) Inventors: Christoph MANGER, Seligenstadt (DE); Didier PERRET, Saint-Imier (CH); Thierry MAIRE, Reignier (FR); Samuel F. LURIE, Poughquag, NY (US); Laura MARKURE, Naugatuck, CT (US); Tom AYARS, Bethel, CT (US); Eugene D. POLLASTRO, Bethel, CT (US); Barry E. KYMER, Beacon Falls, CT (US); Scott CALDWELL, New Milford, CT (US)

(73) Assignee: Branson Ultrasonics Corporation, Brookfield, CT (US)

(21) Appl. No.: 17/520,566

(22) Filed: Nov. 5, 2021

Related U.S. Application Data
(60) Provisional application No. 63/112,397, filed on Nov. 11, 2020.

(51) Int. Cl. B23K 37/04

(52) U.S. Cl. CPC B23K 37/04

(57) ABSTRACT

A work piece processing device includes a work piece processing head supported by an actuator including one of a servo actuator, a pneumatic actuator, a hydraulic actuator, an electric actuator, and a chain drive actuator. A controller uses two or more parameters concurrently in the controls of the work piece processing head and the actuator. According to a further aspect, the controller uses a time duration in the controls in conjunction with a predetermined parameter.

### CROSS-REFERENCE TO RELATED APPLICATIONS

This application claims the benefit of U.S. Provisional Application No. 63/112397, filed on Nov. 11, 2020. The entire disclosure of the above application is incorporated herein by reference.

### FIELD

The present disclosure relates to a dynamic mode work piece processing device.

### BACKGROUND

This section provides background information related to the present disclosure which is not necessarily prior art.

“Work piece processing devices” as used herein are devices that apply force to a work piece (or work pieces) during processing of the work piece and includes ultrasonic welding, vibration welding, laser welding, thermal welding, spin welding, infrared welding and ultrasonic cutting. In some devices, the force is part of and contributes to the performance of the work on a work piece (or work pieces), such as in welding, and in other cases, the force is not part of the performance of the work on the work piece but rather is applied to clamp the work piece in place as the work is performed on the work piece. Such work processing devices have actuators that apply the force to the work pieces such as by moving a tool against the work piece or applying a clamp to the work piece to hold it in place during processing.

Such work piece processing devices can include devices for ultrasonic, vibration, laser, thermal, spin or infrared processing of plastics or metal where force is applied to the work piece, such as welding, staking, swaging, and cutting. Work piece processing devices that apply force to the work piece during processing need actuators that can control both force and position.

U.S. Pat. No. 1,652,082A uses slow motion with a servo actuator until a signal is reached. U.S. Pat. No. 9,144,937B2 uses a time delay at start with a servo actuator. US Patent Application US20200150091A1 also uses a force signal to stop an ultrasonic weld with or without a duration.

Herrmann Ultrashalltechnik uses any process variable to stop an ultrasonic weld on a substantially cylindrical weld with U.S. Pat. No. 9,833,946B2.

It is common practice to use time, distance, energy, collapse distance, and absolute distance alone to control sonic welding, laser welding, vibration welding, thermal welding, spin welding, infrared welding and ultrasonic cutting using pneumatic actuators, and servo actuators.

### SUMMARY

This section provides a general summary of the disclosure, and is not a comprehensive disclosure of its full scope or all of its features.

A work piece processing device includes a work piece processing head supported by an actuator including one of a servo-elastic actuator, a pneumatic actuator, a hydraulic actuator, an electric actuator, and a chain drive actuator. A controller uses two or more parameters concurrently in the controls of the work piece processing head and the actuator. According to a further aspect, the controller uses a time duration in the controls in conjunction with a predetermined parameter.

What is novel in this disclosure is to control the operation of a work processing device (including one of ultrasonic welding, vibration welding, laser welding, thermal welding, spin welding, infrared welding and ultrasonic cutting) with the use of one of:
velocity along with a duration for work processing devices utilizing pneumatic, servo or other actuation technologies;
power along with a duration for work processing devices utilizing pneumatic, servo or other actuation technologies;
a proportion of peak power along with a duration for work processing devices utilizing pneumatic, servo or other actuation technologies;
a proportion of peak absolute distance for work processing devices utilizing pneumatic, servo or other actuation technologies;
a proportion of peak collapse distance for work processing devices utilizing pneumatic, servo or other actuation technologies; or
force along with a duration for work processing devices utilizing pneumatic, servo or other actuation technologies.

Also, what is novel in this disclosure is to control a work processing device with the use of multiple control signals in conjunction with each other either in an ‘or’ condition, an ‘and’ condition, or a sequential condition or combination thereof for ultrasonics, laser, vibration or other welding technologies, utilizing pneumatic, servo or other actuation technologies.

With multiple control signals, the inclusion of including that a control signal is asserted is also novel.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a simplified schematic view of an exemplary work-piece processing device having a servo actuator system in accordance with an aspect of the present disclosure; and

FIG. 2 is a simplified schematic view of an exemplary work-piece processing device having a pneumatic actuator system in accordance with an aspect of the present disclosure.

Corresponding reference numerals indicate corresponding parts throughout the several views of the drawings.

### DETAILED DESCRIPTION

Example embodiments will now be described more fully with reference to the accompanying drawings.

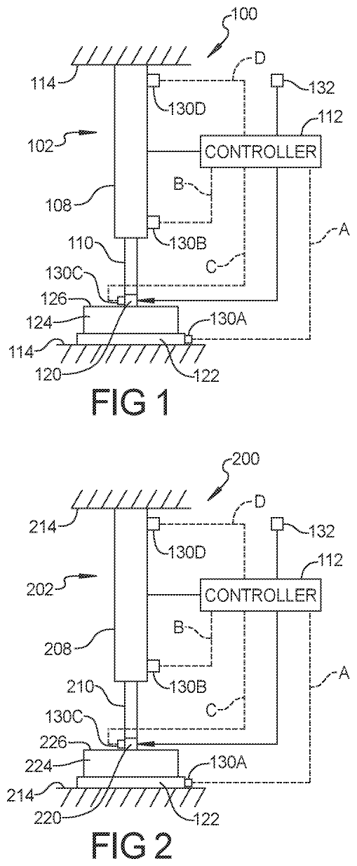

With reference to FIG. 1, a work-piece processing device 100 includes a servo-actuator system 102. Servo-actuator system 102 includes a servo-motor 108 and an actuator member 110 coupled to servo-motor 108 that is moved up and down (as oriented in the drawings) by the servo-elastic actuator system 102. Servo motor 108 is coupled to a controller 112 that controls actuator system 102. Actuator system 102 can be affixed to a frame 114 or other structure of device 100. An end of the actuator member 110 is affixed to a tool device 120. Device 100 also includes a work piece holder 122, which for example could be an anvil of an ultrasonic welder or ultrasonic tube sealer. Work piece holder 122 is affixed to frame 114 of device 100. A work piece 124 is situated on work piece holder 122. Work piece 124 is a work piece that is to be processed by device 100. Work piece 124 can for example be two plastic or metal pieces that are to be ultrasonically welded together when device 100 is an ultrasonic welder. Work piece 124 can for example be a tube that is to have an end ultrasonically sealed when device 100 is an ultrasonic tube sealer. Tool device 120 is that part of the work piece processing device that is pressed against work piece 124 by the movement of servo-actuator 104 to process work piece 124. Tool device 120 may be, for example, an ultrasonic stack of an ultrasonic welder or an ultrasonic sealer or a tip of an ultrasonic horn. The ultrasonic stack is what physically contacts work piece 124. In such cases, tool device 120 is energized ultrasonically to work on work piece 124 to process it, such as by ultrasonic welding or ultrasonic sealing, as applicable. The tool device 120 can include an ultrasonic welder, vibration welder, laser welder, thermal welder, spin welder, infrared welder and ultrasonic cutter. It should be understood that the work piece processing device 100 can take on alternative forms including those that are disclosed in commonly assigned US published patent application 2019/0262956A1 which is herein incorporated by reference in its entirety. In addition, the tool device 120 could be at the end opposite to the actuator 110, and the work piece holder 122 could be on the actuator to press the work piece against the tool device as an additional possibility.

With reference to FIG. 2, a work-piece processing device 200 includes a pneumatic-actuator system 202. Pneumatic-actuator system 202 includes a pneumatic device 208 and an actuator member 210 coupled to pneumatic device 208 that is moved up and down (as oriented in the drawings) by the pneumatic device 208. Actuator system 202 is coupled to a controller 112 that controls pneumatic actuator device 208. Pneumatic actuator device 208 is affixed to a frame 214 of device 200. An end of actuator member 210 is affixed to a tool device 220. Device 200 also includes a work piece holder 222, which for example could be an anvil of an ultrasonic welder or ultrasonic tube sealer. Work piece holder 222 is affixed to frame 214 of device 200. A work piece 224, which has a relatively non-compliant or stiff surface 226, is situated on work piece holder 222. Work piece 224 is a work piece that is to be processed by device 200. Work piece 224 can for example be two plastic or metal pieces that are to be ultrasonically welded together when device 200 is an ultrasonic welder. Work piece 224 can for example be a tube that is to have an end ultrasonically sealed when device 200 is an ultrasonic tube sealer. Tool device 220 is that part of work piece processing device that is pressed against work piece 224 by the movement of pneumatic-actuator 204 to process work piece 224. Tool device 220 may for example be an ultrasonic stack of an ultrasonic welder or an ultrasonic sealer and a tip of an ultrasonic horn of the ultrasonic stack is what physically contacts work piece 224. In such cases, tool device 220 is energized ultrasonically to work on work piece 224 to process it, such by ultrasonic welding or ultrasonic sealing, as applicable. The tool device 220 can include an ultrasonic welder, vibration welder, laser welder, thermal welder, spin welder, infrared welder and ultrasonic cutter. It should be understood that the work piece processing device 200 can take on alternative forms including those that are disclosed in commonly assigned US published patent application 2019/0262956A1 which is herein incorporated by reference in its entirety. In addition, the tool device 220 could be at the end opposite to the actuator 210, and the work piece holder 222 could be on the actuator to press the work piece against the tool device as an additional possibility.

Controller 112 can be or includes any of a digital processor (DSP), microprocessor, microcontroller, or other programmable device which are programmed with software implementing the herein described logic. It should be understood that alternatively it is or includes other logic devices, such as a Field Programmable Gate Array (FPGA), a complex programmable logic device (CPLD), or application specific integrated circuit (ASIC). When it is stated that controller 112 performs a function or is configured to perform a function, it should be understood that controller 112 is configured to do so with appropriate logic (such as in software, logic devices, or a combination thereof), as applicable. When it is stated that controller 112 has logic for a function, it should be understood that such logic can include hardware, software, or a combination thereof. The controller 112 is in communication with appropriate sensors 130 for detecting the various work piece processing device parameters discussed herein. The controller 112 can further include or communicate with a timer 132 for detection of the duration of a processing step, i.e. ultrasonic welding, vibration welding, laser welding, thermal welding, spin welding, infrared welding and ultrasonic cutting.

In this disclosure, the initiation of sonics in ultrasonics, the initiation of an amplitude step of sonics, the stopping of an amplitude step, and/or the stopping of sonics in ultrasonics are triggered by the condition of one parameter, or a combination of the conditions of more than one parameter.

In addition, in this disclosure, the initiation of laser in a laser process, the initiation of an amplitude step of laser, the stopping of an amplitude step, and/or the stopping of laser in a laser process is triggered by the condition of one parameter, or a combination of the conditions of more than one parameter.

Also, in this disclosure, the initiation of a force or down speed, the initiation of a force or down speed step, the stopping of a force or down speed step, and/or the stopping of force or down speed. All of these can be utilized with pneumatic, servo or other actuation technologies and used for ultrasonics, laser, vibration or other welding technologies.

For one parameter control for a duration, the present disclosure can use one of:
A velocity signal greater or equal to a setting, or less than or equal to a setting for a predetermined duration. A velocity or position sensor 130B can be used for providing a velocity signal “B”;
A power signal applied to the tool device 120/220 is greater or equal to a setting, or less than or equal to a setting for a predetermined duration. A power sensor and/or energy sensor 130C can be used for providing a power signal “C”;
A power applied to the tool device 120/220 is less than or equal to a set portion of detected peak power for a predetermined duration. The power sensor and/or energy sensor 130C can be used for providing a power signal “C”;
An applied force is greater or equal to or less than or equal to a setting for a predetermined duration. The force can include a pneumatic or servo actuator force or a compression spring force. A force sensor 130D can be used for providing a force signal “D”;
An absolute distance is less than or equal to a set portion of detected peak absolute distance for a predetermined duration, where “absolute distance” is the total distance traveled by the actuator to complete the weld, measured from the starting position of the actuator. The velocity or position sensor 130B can be used for providing a distance signal “B”;
An absolute distance is less than or equal to a set portion of detected peak absolute distance. A velocity, acceleration or position sensor 130B can be used for providing a distance signal “B”;
A collapse distance is less than or equal to a set portion of a detected peak collapse distance for a predetermined duration, where “collapse distance” is the distance traveled by the actuator to complete the weld, measured from the position of contact with the part. The velocity or position sensor 130B can be used for providing a distance signal “B”; or
A collapse distance is less than or equal to a set portion of a detected peak collapse distance. The velocity or position sensor 130B can be used for providing a distance signal “B”.

For multi-parameter control of a work processing device, the disclosure can use:
A velocity greater or equal to, or less than or equal to a set value;
A velocity signal is greater or equal to, or less than or equal to a set value for a duration
A power greater or equal to, or less than or equal to a set value
A power signal is greater or equal to, or less than or equal to a setting for a duration;
A power less than or equal to a set portion of detected peak power;
A power signal is less than or equal to a set portion of detected peak power for a duration;
A force greater or equal to, or less than or equal to a set value;
A force signal (measured by a strain gauge in a pneumatic system and calculated based upon spring compression in a servo system) is greater or equal to, or less than or equal to a setting for a duration;
A time greater or equal to a set value;
An energy greater or equal to a set value;
An energy is greater or equal to a setting for a duration;
An absolute distance greater or equal to or less than or equal to a set value;
An absolute distance is greater or equal to or less than or equal to a setting for a predetermined duration;
An absolute distance is less than or equal to a set portion of detected peak absolute distance for a duration;
An absolute distance is less than or equal to a set portion of detected peak absolute distance;
A collapse distance greater or equal to or less than or equal to a set value;
A collapse distance is greater or equal or less than or equal to a setting for a duration;
A collapse distance is less than or equal to a set portion of detected peak collapse distance for a duration;
A collapse distance is less than or equal to a set portion of detected peak collapse distance.
   It is noted that parameters labeled “signal” can refer to internal feedback within the system, instead of a direct measurement by a measurement device attached to the system.

In the disclosure, multi-parameters can be sequenced in priority for assertion, can be ‘and’ed for assertion, can be cored for assertion, or combinations thereof can be asserted.

For one parameter control, any or all the parameters listed can be included in the embodiment. Preferentially, all of the one control parameters are included in the embodiment.

For multi-parameter control, any or all of the parameters listed can be included in the embodiment. Preferentially, all of the control multi-parameters are included in the embodiment.

Any of the Booleans of ‘and’, ‘or’, or sequenced can be included in the embodiment but preferentially all the Booleans are used.

The ultrasonics can include metal welding, plastics welding, staking, swaging, sonification, marking and cutting.

The lasers can include metal welding, plastics welding, staking, marking, cutting, and cleaning.

The use of the one parameter and multi-parameter control signals allows for more flexibility in controlling a work processing device.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. For example, the tool device could be at the end opposite to the actuator, and the work piece holder could be on the actuator as an additional possibility. The same may also be varied in many ways. Such variations are not to be regarded as a departure from the disclosure, and all such modifications are intended to be included within the scope of the disclosure.

What is claimed is:

1. A work piece processing device comprises:
a work piece processing head;
a work piece holder opposite the work piece processing head;
an actuator including one of a servo actuator, a pneumatic actuator, hydraulic actuator, electric actuator, and a chain drive actuator drivingly connected to one of the work piece processing head and the work piece holder; and
a controller that uses two or more parameters concurrently in the controls of the work piece processing head and the actuator.

2. The work piece processing device according to claim 1, wherein the two or more parameters includes a velocity greater or equal to, or less than or equal to a set value.

3. The work piece processing device according to claim 1, wherein the two or more parameters includes a velocity signal is greater or equal to, or less than or equal to a set value for a predetermined duration.

4. The work piece processing device according to claim 1, wherein the two or more parameters includes a power greater or equal to, or less than or equal to a set value.

5. The work piece processing device according to claim 1, wherein the two or more parameters includes a power signal is greater or equal to, or less than or equal to a setting for a predetermined duration.

6. The work piece processing device according to claim 1, wherein the two or more parameters includes a power less than or equal to a set portion of detected peak power.

7. The work piece processing device according to claim 1, wherein the two or more parameters includes a power signal is less than or equal to a set portion of detected peak power for a predetermined duration.

8. The work piece processing device according to claim 1, wherein the two or more parameters includes a force greater or equal to, or less than or equal to a set value.

9. The work piece processing device according to claim 1, wherein the two or more parameters includes a force signal is greater or equal to, or less than or equal to a setting for a predetermined duration.

10. The work piece processing device according to claim 1, wherein the two or more parameters includes a time greater or equal to a set value.

11. The work piece processing device according to claim 1, wherein the two or more parameters includes an energy greater or equal to a set value.

12. The work piece processing device according to claim 1, wherein the two or more parameters includes an energy is greater or equal to a setting for a predetermined duration.

13. The work piece processing device according to claim 1, wherein the two or more parameters includes an absolute distance greater or equal to or less than or equal to a set value.

14. The work piece processing device according to claim 1, wherein the two or more parameters includes an absolute distance is greater or equal to or less than or equal to a setting for a predetermined duration.

15. The work piece processing device according to claim 1, wherein the two or more parameters includes an absolute distance is less than or equal to a set portion of detected peak absolute distance for a predetermined duration.

16. The work piece processing device according to claim 1, wherein the two or more parameters includes an absolute distance is less than or equal to a set portion of detected peak absolute distance.

17. The work piece processing device according to claim 1, wherein the two or more parameters includes a collapse distance greater or equal to or less than or equal to a set value.

18. The work piece processing device according to claim 1, wherein the two or more parameters includes a collapse distance is greater or equal or less than or equal to a setting for a predetermined duration.

19. The work piece processing device according to claim 1, wherein the two or more parameters includes a collapse distance is less than or equal to a set portion of detected peak collapse distance for a predetermined duration.

20. The work piece processing device according to claim 1, wherein the two or more parameters includes a collapse distance is less than or equal to a set portion of detected peak collapse distance.

21. The work piece processing device according to claim 1, wherein the work piece processing head is one of an ultrasonic, vibration, laser, thermal, spin or infrared processing device of plastics or metal where force is applied to the work piece, to perform one of welding, staking, swaging, and cutting.

22. A work piece processing device comprises:
a work piece processing head;
an actuator including one of a servo actuator, a pneumatic actuator, hydraulic actuator, electric actuator, and a chain drive actuator connected to the work piece processing head; and
a controller that uses a time duration in the controls in conjunction with a predetermined parameter in the controls of the work piece processing head and the actuator.

23. The work piece processing device according to claim 22, wherein the parameter includes a velocity signal greater or equal to, or less than or equal to a predetermined setting for a predetermined duration.

24. The work piece processing device according to claim 22, wherein the parameter includes a power signal is greater or equal to, or less than or equal to a setting for a predetermined duration.

25. The work piece processing device according to claim 22, wherein the parameter includes a power is less than or equal to a set portion of detected peak power for a predetermined duration.

26. The work piece processing device according to claim 22, wherein the parameter includes a force is greater or equal to or less than or equal to a setting for a predetermined duration.

27. The work piece processing device according to claim 22, wherein the parameter includes an absolute distance is less than or equal to a set portion of detected peak absolute distance for a duration, where absolute distance is a total distance traveled by the actuator to complete a weld, measured from a starting position of the actuator;

28. The work piece processing device according to claim 22, wherein the parameter includes an absolute distance is less than or equal to a set portion of a detected peak absolute distance.

29. The work piece processing device according to claim 22, wherein the parameter includes a collapse distance is less than or equal to a set portion of detected peak collapse distance for a predetermined duration, where collapse distance is a distance traveled by the actuator to complete a weld, measured from the position of contact with the part.

30. The work piece processing device according to claim 22, wherein the parameter includes a collapse distance is less than or equal to a set portion of detected peak collapse distance.

31. The work piece processing device according to claim 22, wherein the work piece processing head is one of an ultrasonic, vibration, laser, thermal, spin or infrared processing device of one of plastics or metal where force is applied to a work piece, to perform one of welding, staking, swaging, and cutting.
